(19) United States
(12) Patent Application Publication
(10) Pub. No.: US 2011/0135870 A1
(43) Pub. Date: Jun. 9, 2011

(54) HARDBOARD AND LAMINATES AND METHOD OF MAKING

(76) Inventors: Klaus Friedrich Gleich, Highlands Ranch, CO (US); Jawed Asrar, Englewood, CO (US)

(21) Appl. No.: 12/633,497

(22) Filed: Dec. 8, 2009

(51) Int. Cl. B32B 9/04; B29C 70/40

(52) U.S. Cl. 428/95; 264/258

(57) ABSTRACT

Hardboards and laminates containing one or more layers of scrap carpet, with or without optional external and/or internal layers of other materials, including fibers, particles, liquids, woven and nonwoven fibrous mats, fabric and scrim, and shredded scrap carpet, and the are disclosed. The systems and methods for making the hardboard and laminates using cyclical or continuous hot consolidation are also disclosed. Various uses for the hardboard and laminates are also disclosed.

This invention involves laminates containing one or more layers of thermoplastic polymeric scrap carpet and methods of making the laminates. The laminates resemble hardboard and have many uses including backing and drawer bottoms for furniture, backing for cabinets of all kinds, building construction, automotive parts, etc.

Scrap carpet exists as defective for various reasons at the carpet manufacturer, wholesaler, retailer or carpet laying service. This scrap can be in large pieces, small pieces, and edge trim. Scrap carpet also exists as used carpet when removed from floors to be replaced with new carpet or other floor covering. This scrap can also exist as large pieces, small pieces and narrow strips. In the past most of this scrap has been discarded, usually in landfills or burned. Normally, carpet is comprised of tufted yarns of wool, cotton or any one of several polymers including nylon, polyester, an olefin, polyethylene terephthalate (PET) and others, a woven or nonwoven backing of polymer fibers, usually polypropylene, polyester spunbond and/or glass fiber nonwovens and a thermoplastic adhesive, often a filled styrene butadiene rubber, bonding the tufted yarns to the backing.

Proposals exist to use at least some of these kinds of scrap carpet to make products. These proposals and inventions all include a step of first shredding the scrap carpet into very small pieces and then either hot extruding to form pellets or hot pressing to form various shapes. Also, often the polymeric yarn is sheared off of the backing and only this sheared off yarn or tufts are used with the backing and adhesive being discarded. These shredding and/or shearing steps are expensive and often do not result in using all of the scrap carpet to make the product. Usually one or more other materials are added before forming such as new polymer, reinforcing fibers, fillers, colorants etc. Some of these processes are disclosed in U.S. Pat. Nos. 5,294,384, 5,591,802, 6,387,967 and 6,756,412. Adding new polymer and some other ingredients to the shredded or sheared scrap also adds substantial cost to the process and products.

### SUMMARY

Applicant has discovered that if one or more layers, typically two or more layers of scrap thermoplastic carpet comprising thermoplastic tufted yarn bonded to a woven or nonwoven, thermoplastic or glass fiber backing with a cured thermoset or thermoplastic binder is hot pressed, while the scrap carpet is at an elevated temperature sufficient to melt or soften all or at least most of the thermoplastic material in the scrap carpet, a useful hardboard or laminate can be produced. The scrap carpet can be large sized pieces and/or small sized pieces, or thin strips, of defective or used carpet, but usually is large sized pieces or small sized pieces. For purposes of the disclosure of the invention, large sized pieces are defined as being larger than 2 feet wide by 1 foot long in one or both dimensions, small pieces are defined as being 4 inches to 2 feet in width and greater than 4 inches in length and narrow strips are defined as being 4 inches or less in width and of any length. For purposes of the description of the invention herein, scrap carpet includes clean or uncleaned used carpet, trim and/or leftover pieces of carpet after installations, defective or discarded carpet in the manufacturing plants or prior to or after installation, and/or unwanted (for any reason) carpet.

The layer(s) of scrap carpet can also contain one or more layers of any type and form of fibers, loose or bonded or woven together in any product or scrap and/or one or more layers of shredded new and/or scrap carpet with or without one or more layers of thermoplastic polymer(s) in any form, with or without a material selected from the group consisting of filler, pigment, cross linking agent, catalyst or other functional ingredient.

The invention also includes methods of making a hardboard or laminate by heating, and pressing while hot, one or more layers, typically two or more layers of scrap thermoplastic carpet comprising thermoplastic tufted yarn bonded to a woven or nonwoven, thermoplastic or glass fiber backing with a cured thermoset or thermoplastic binder with or without one or more layers of any type and form of fibers, loose or bonded or woven together in any product or scrap and/or one or more layers of shredded new and/or scrap carpet with or without one or more layers of thermoplastic polymer(s) in any form, with or without a material selected from the group consisting of filler, pigment, cross linking agent, catalyst or other functional ingredient, and then cooling the hot pressed hardboard or laminate. Laminates can also be made by bonding the hardboard or laminate just described to one or two layers of a different material by hot pressing to cause the one or two layers of the different material to bond to the top or bottom of the hardboard or laminate, or by using an adhesive or other fastening means.

When the word “about” is used herein it is meant that the amount or condition it modifies can vary some beyond that stated so long as the advantages of the invention are realized. Practically, there is rarely the time or resources available to very precisely determine the limits of all the parameters of one's invention because to do so would require an effort far greater than can be justified at the time the invention is being developed to a commercial reality. The skilled artisan understands this and expects that the disclosed results of the invention might extend, at least somewhat, beyond one or more of the limits disclosed. Later, having the benefit of the inventors' disclosure and understanding the inventive concept and embodiments disclosed including the best mode known to the inventor, the inventor and others can, without inventive effort, explore beyond the limits disclosed to determine if the invention is realized beyond those limits and, when embodiments are found to be without any unexpected characteristics, those embodiments are within the meaning of the term “about” as used herein. It is not difficult for the artisan or others to determine whether such an embodiment is either as expected or, because of either a break in the continuity of results or one or more features that are significantly better than reported by the inventor, is surprising and thus an unobvious teaching leading to a further advance in the art.

### BRIEF DESCRIPTION OF THE DRAWINGS

FIGS. 1-6 show some embodiments of hardboard or laminates of the invention.

FIG. 7 shows equipment in a process for making hardboard or laminates such as the embodiments shown in FIGS. 1-6.

FIG. 8 shows equipment in a process for making precursors for hardboards or laminates such as embodiments shown in FIGS. 1-6.

FIG. 9 shows equipment in another continuous process for making hardboards or laminates including the embodiments shown in FIGS. 1-6, using various precursors such as those made in the process shown in FIG. 8.

FIG. 10 shows equipment similar to that shown in FIG. 7, but modified, in a process to make textured and/or shaped hardboard or laminates including the embodiments shown in FIGS. 1-6.

### DETAILED DESCRIPTION OF SOME EMBODIMENTS AND THE BEST MODE

Scrap carpet is comprised of yarn of various polymers that are tufted and/or attached to a backer mat by an adhesive, usually a thermoplastic adhesive, although some carpet uses a cured thermoset resin or binder to attach the yarn to the backer mat. The polymers used for the yarn are most typically some form of nylon, acrylic (polyacrylonitrile), olefin (polypropylene and/or polyethylene), and polyester. The yarns can be in the form of one or more of twisted, air-tangled, plied, cabled, and heat-set configurations

The backer mat is scrap carpet is usually a woven or nonwoven fibrous fabric or mat that can contain a thermoplastic or cured thermoset binder, particularly the nonwoven mats. The fibers in the woven fabric backers or nonwoven mat backers can be a polymer like the thermoplastic polymers used in the yarns described above or glass or a combination of these.

The adhesives used in carpets to bond the yarn to the backer fabric or mat typically comprise thermoplastic polymers, but can also be a thermoset resin that is cured in the carpet making process.

The hardboard or laminate products of the invention can also include one or more layers of material selected from the group comprising a virgin or recycled thermoplastic polymer or polymers, a fiber layer, fibrous mat, fabric or scrim containing natural, inorganic, polymer and/or carbon fibers, a foam product, a wood product, a ceramic product, a rubber product, a gypsum product, a cementitious product, a metal product, a cured thermoset polymer product, a glass product and one or more functional additives including a catalyst, a biocide, a pesticide, filler, pigment, dye, foaming agent and an electrically conducting material.

FIG. 1 shows one embodiment product, a hardboard or laminate 2, of the invention with a layer of consolidated thermoplastic fibers 3, from yarn or tow, and a consolidated layer 4 comprising a blend of the carpet backing mat or fabric and the adhesive bonding the yarn or tow fibers to the backing mat. A laminate 2 can also optionally have one or two optional exterior layers 9. The optional exterior layer(s) 9 comprise one or more materials or items selected from a group comprising or consisting of a fibrous material in which the fibers are bound together, woven, or loose, and of any material, pigment and/or filler with or without a binder of any kind, one or more layers of leather, wood or wood product, plastic, ceramic, cementitious material, metal and carbonaceous material and any combination thereof. The fibrous layer in any of the figures can also be pre-impregnated with a thermoplastic resin or with a b-staged thermoset resin. Any layer, particularly the top and/or bottom layers in any of the embodiments can also include paper or film including printed decorative papers and films. One type of plastic includes a decorative layer like vinyl containing a design with or without color or colors. The fibrous layer includes woven, any density of nonwoven or loose fibers of glass, polymer(s), ceramic, other inorganic, natural, carbon and metal and any combination thereof. The cementitious layer can include gypsum, cement or any hydraulic setting material. The fibrous layer also includes paper in any form, and the other materials include layers in any form including honeycomb, crimped, creped etc. All materials including polymer(s) and natural materials layers include one or more foamed or highly porous materials including one or more polymers, rubber, resin, metal and cementitious materials.

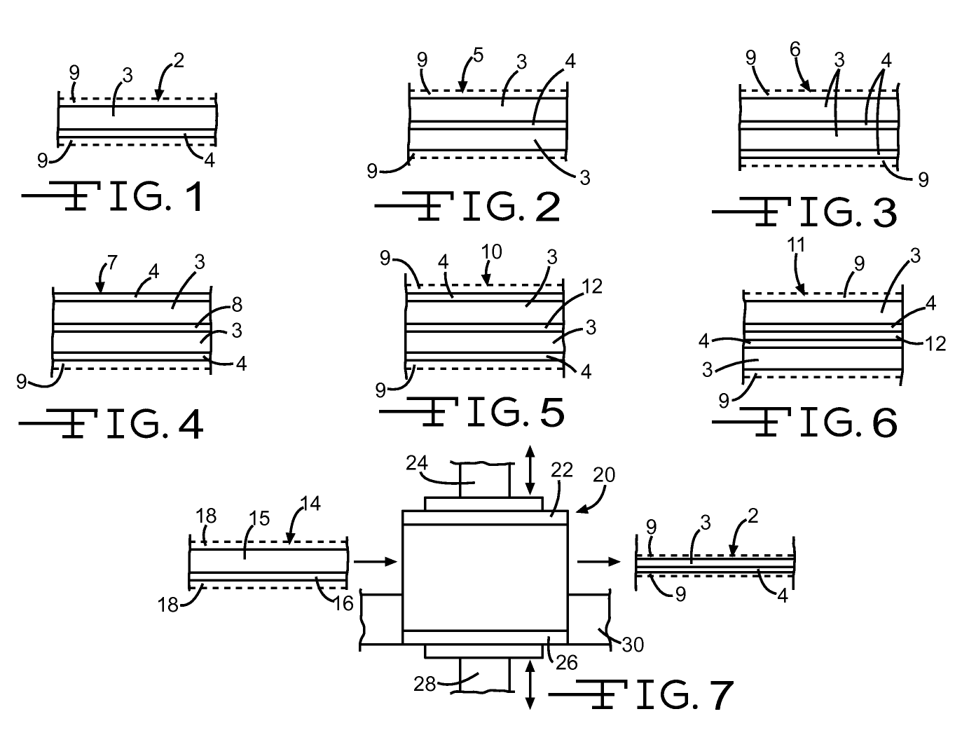

FIG. 2 shows a hardboard or laminate 5 of the invention comprising two or more layers of consolidated thermoplastic fibers 3 with a consolidated layer 4 comprising a blend of two carpet backing mats or fabrics and the adhesive bonding the yarn or tow fibers to the two backing mats made by hot pressing two layers of scrap carpet together with the two backing mats contacting one another. An optional layer 9, as described above, can be on one or both outer layers of the laminate 5. The laminate 5 can have 3, 4, 5, 6 or any greater number of layers 3 and 4, always with a layer of consolidated thermoplastic fibers 3 in contact with a consolidated layer 4 comprising a blend of one or more carpet backing mats or fabrics and the adhesive bonding the yarn or tow thermoplastic fibers to the backing mat(s) and/or fabric(s), and always with two layers 3 being either exposed or in contact with an optional exterior layer 9.

FIG. 3 shows a still further hardboard or laminate 6 of the invention. The laminate 6 is made by hot pressing two or more layers of scrap carpet mat together such that only one layer of consolidated thermoplastic fibers 3 is either exposed or in contact with an optional exterior layer 9 and that only one consolidated layer 4 comprising a blend a carpet backing mat or fabric and the adhesive bonding the yarn or tow thermoplastic fibers to the backing mat or fabric.

FIG. 4 shows a laminate 7 comprising two or more layers 3 of consolidated thermoplastic fibers having an interior layer 8 between two layers 3, and a layer 4 comprising a blend a carpet backing mat or fabric and the adhesive bonding the yarn or tow thermoplastic fibers to the backing mat or fabric in contact with each layer 3. The layer 8 can be comprised of or consist essentially of the same items and materials as the optional exterior layer 9 described above. The laminate 8 can also comprise one or two of the exterior optional layers 9.

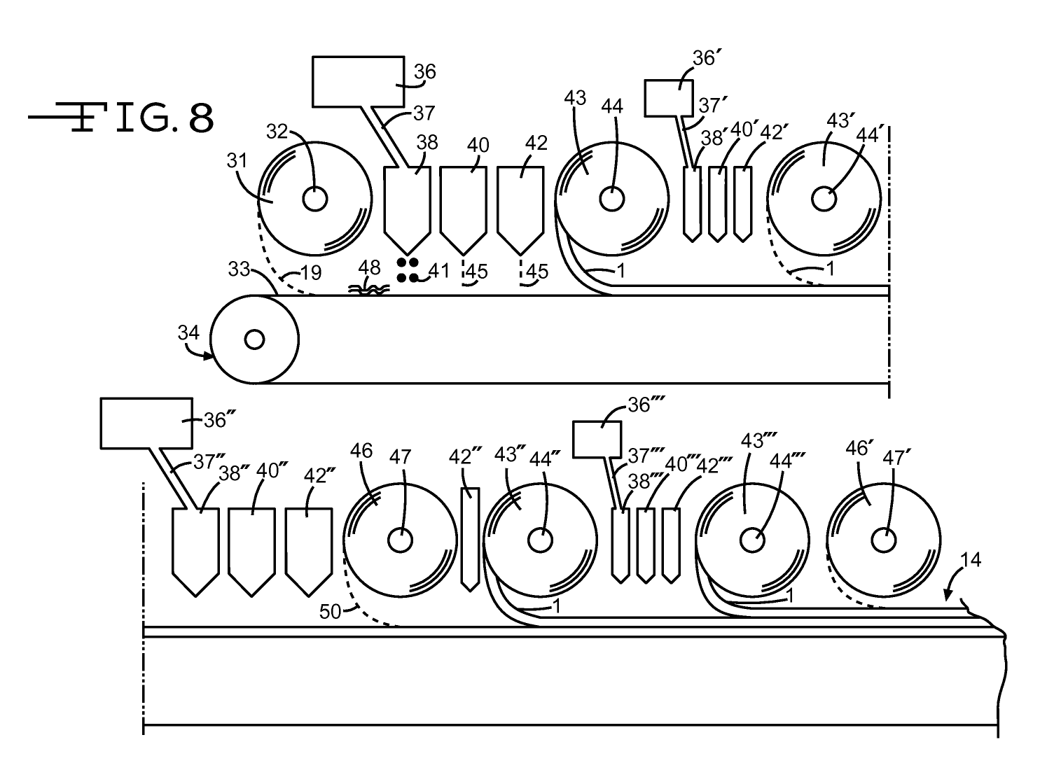

FIG. 5 includes a laminate 10 comprising two or more layers 3 of consolidated thermoplastic fibers, with at least two of the layers 3 being bonded to an enhanced interior layer 12. The enhanced interior layer 12 comprises or consists of one or more virgin thermoplastic or thermosetting polymers, copolymers or precursor(s) of the polymer(s) and/or a layer of shredded scrap carpet in or on the previously described material, the enhanced interior layer 12 can also optionally contain one or more materials that comprise the optional exterior layer 9 as described above. The laminate 10 also contains two or more layers 4, each comprising a blend a carpet backing mat or fabric and the adhesive bonding the yarn or tow thermoplastic fibers to the backing mat or fabric, each consolidated layer 4 either exposed (exposed as an outside layer of the laminate) or in contact with an optional exterior layer 9.

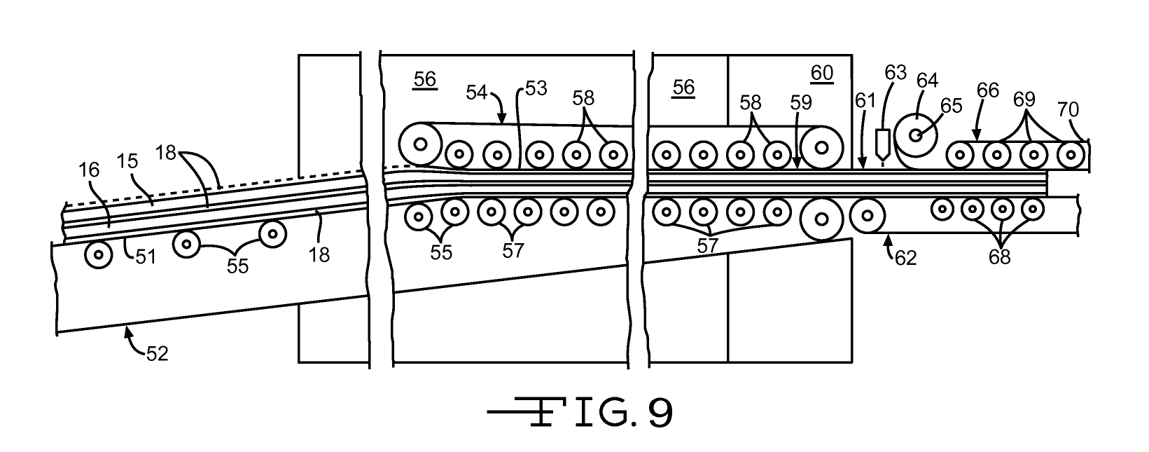

FIG. 6 shows a still further laminate 11 of the invention. The laminate 11 contains two or more layers of consolidated scrap carpet and containing at least one of the enhanced interior layers 12, described above, bonded to two consolidated layers 4, each comprising a blend a carpet backing mat or fabric and the adhesive bonding the yarn or tow thermoplastic fibers to the backing mat or fabric. The laminate 11 shown has two layers of consolidated thermoplastic fibers 3 with one or two of the layers 3 being either exposed or in contact with an optional exterior layer 9 as described above, and, when more than two of the consolidated thermoplastic fiber layer 3 are present in the laminate 11, at least one of the consolidated thermoplastic layers 3 can have both surfaces in contact with the consolidated layer 4. Like the other laminates, laminate 11 can have the optional exterior layer 9 as one or both exterior layers of the laminate.

Most typically the precursor of the one or more layered hardboards or laminates of the invention is heated to an elevated temperature prior to consolidating by pressing, most typically in a press in which one or more of the platens and the mold are heated to the molding temperature, however, the precursor can be at ambient temperature or other temperatures below the desired consolidation temperature and heated in the heated press either prior to consolidating with pressure or during pressing to consolidate the scrap carpet and any other optional layer(s). FIG. 7 shows a typical system for making the hardboard and laminates of the invention. In this system and process a precursor 14 is provided comprising one or more layers of scrap carpet comprising an unconsolidated layer of thermoplastic polymer fibers and an unconsolidated layer 16 comprising a backer mat or fabric and adhesive, usually a thermoplastic adhesive. The precursor can also contain one or two unconsolidated optional exterior layers comprising the same materials, often in unconsolidated form, as the consolidated optional exterior layers 9 described above. The precursor 14 is desirably preheated to a temperature at or near where all of the thermoplastic ingredients in at least the scrap carpet layers are in a thermoformable state, such as being heated throughout in a static oven to or near the desired temperature, or being run through an oven on a moving belt or rollers at a sufficient temperature and with sufficient dwell time to accomplish the heating.

The resultant precursor 14, being preheated is then moved into a press 20, also desirably, but not necessarily, having precursor 14 contacting parts heated to the desired consolidating temperature. The presses shown is a conventional double acting press comprising an upper platen 22 connected to an upper rod 24 that moves the upper platen 22 up, and down with a consolidating level of force, a lower platen 26 connected to a lower rod 28 that moves the lower platen 26 down and upward with a consolidating force and then, when the upper platen 22 is raised, with an ejecting force. The platens 22, 26 consolidate the precursor 14 inside a mold 30 that usually completely surrounds the periphery of the precursor 14. The upper platen 22, the lower platen 26 and the mold 30 can be heated to or near the desired consolidating temperature in any known manner. When the precursors 14 are preheated, particularly to a temperature above the desired consolidating temperature and are being rapidly consolidated, ejected and recharged with preheated precursors, the press will become sufficiently preheated with the contact with the preheated precursors 14 in which case the platens 22, 26 and mold 30 need not be heated by internal heating means, however, the initial production, until the platens 22, 26 and mold 30 get up to desired temperature, may not be sufficiently consolidated. Also, it is not necessary to preheat the precursors when the platens 22, 26 and mold 30 contain heating means, but the consolidating cycle time will be much slower than if the precursors are preheated because of the time required to heat the precursor to consolidating temperature by contact with the heated platens 22, 26 and heated mold 30.

The amount of consolidating force or pressure will vary depending upon many factors including the composition of the precursor, the type(s) of polymers and/or copolymers in the scrap carpet, the temperature of the precursor 14, the materials in the optional exterior layer(s) 18, when present the materials in the layer 12 and with the desired properties including density and porosity of the hardboard or laminates of the invention. The consolidating forces are usually applied either mechanically or with one or more hydraulic cylinders attached to each of the upper platen 22 and the lower platen 26.

The preheating and/or consolidating temperature will usually depend upon the highest softening temperature or the polymer or copolymer having the highest glass transition temperature, Tg, of the thermoplastic polymer(s) and/or copolymer(s) in the precursor 14 and with the desired consolidating time. The viscosity of the thermoplastic polymer(s) and/or copolymer(s) will depend upon their temperature, the higher the temperature, the lower the viscosity, up to the point where the polymer(s) and/or copolymer(s) totally melt or begin to degrade or decompose. Therefore, for the shortest consolidating time, the temperature of the precursor 14 should be just below the temperature at which one or more of the polymers and/or copolymers begin to degrade or decompose. The cycle time will also depend upon the magnitude of the consolidating force of the platens 22, 26, or more specifically the pressure applied to the precursor 14, the higher the consolidating pressure, the shorter the consolidating or cycle time.

When the desired degree of consolidation of the precursor 14 is achieved, the top platen 22 is withdrawn by the rod 24 and the consolidated hardboard or laminate 2 is ejected from the mold by the rod 28 moving the platen 26 upward to eject the hot hardboard or laminate 2 from the mold 30. At this time the hot hardboard or laminate 2 is removed or pushed off of the lower platen 26 and cooled to solidify or harden to produce the hardboard or laminate 2 product, or whatever hardboard or laminate product is being produced. The process and system of FIG. 7 is particularly useful in producing hardboard or laminate products of the invention from small pieces of scrap carpet. The hardboards or laminates of the invention need not be flat or planar, but can be textured or shaped. One or both of the platens 22, 26 can be textured or shaped or configured, other than planar, to form a textured or shaped hardboard or laminate in known ways. such as for making products including column pieces, room trim, cabinet pieces, and the like. It is also possible to use a multi-opening press with heating and/or cooling systems. With such a press, the back-cooling allows one to defom a completely formed and cooled product. Instead of using a single press of this known type, it is also possible to shuttle hot, formed products to a cold press for final forming and shaping.

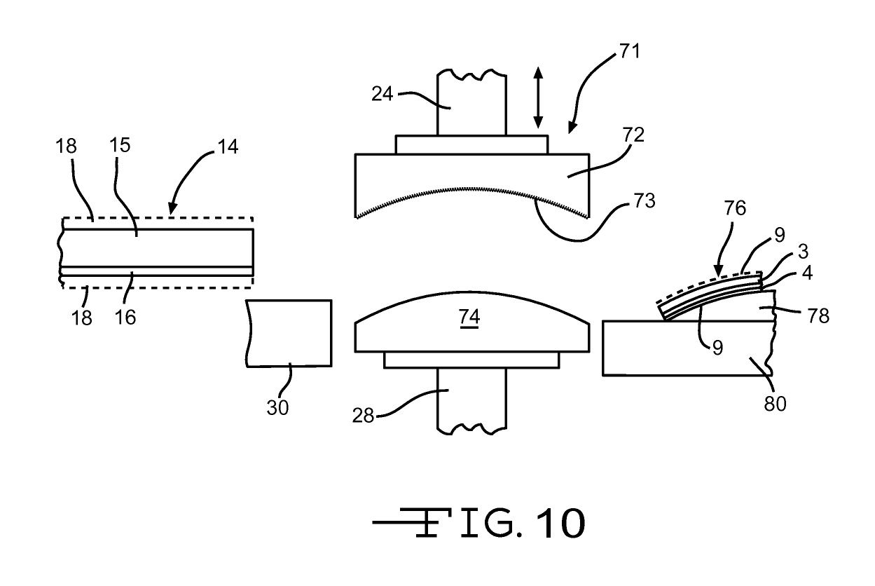

FIG. 8 shows a continuous system and process using conventional equipment that can be used to prepare various precursors to make the hardboards or laminates of the invention from scrap carpet and various other ingredients, particularly large pieces or strips of scrap carpet, but is also usable with small pieces of scrap carpet as will be described below. The system comprises a conventional moving belt conveyor comprised of a moving belt 33 and a tail pulley 34. As the belt 33 moves away from the tail pulley 34 various ingredient layers making up a precursor 14 of the hardboards and laminates of the invention are laid down sequentially, or some congruently, until the desired precursor 14 is obtained. First, optionally, a lower layer of the optional precursor external layer 19 can be laid onto the conveyor belt 33 from a roll 31 on a rotating mandrel 34, or a conventional piece feeder feeding large or small pieces of the optional precursor external layer 19 (not shown) such as a vibratory feeder, can be used instead. The first layer, or second layer, can optionally be a layer of scrap carpet 1, in which case, a roll of scrap carpet, or a carpet piece feeder, would be used instead of the roll 31 on the mandrel 34. Wherever a roll of scrap carpet, or scrap carpet piece feeder, exists in the precursor forming system, two or more rolls of scrap carpet can optionally be present to lay down two or more layers of scrap carpet 1.

Next, optionally, a layer of shredded scrap carpet 48, made with a conventional piece feeder 36 feeding pieces or strips or rolls of scrap carpet 1 down an optional slide 37 into a conventional carpet shredder 38, can be fed and laid in a layer onto the belt 33 or onto a lower optional external layer 19. Such a piece feeder includes conventional vibratory feeders and such a carpet shredder includes SSI Q55 or Q70 Quad™ shredders, Komar® Industries of Groveport, Ohio, Tiger 4 Hydro-quad shear shredders or Vecoplan USA's RG 52K or 50K shredders. These shredders can handle open pieces or rolls of scrap carpet and reduce the scrap carpet to a compressible fibrous fluff of various sizes, e.g. about 4 inch bundles or smaller, 3 inches or smaller, 2 inches or smaller, 1 inch and smaller and 0.5 inch and smaller. The smallest pieces can be best produced by placing two or more shredders in series. The shredded scrap carpet 48 can be metered and fed onto a layer of a partial precursor using conventional picker feeders, feeders having a series of rotating spindles having spaced apart pins protruding from center shafts, and with conventional vibratory feeders.

Next a feeder 40 capable of metering particles 41, with or combined with a liquid, can be metered to form an optional layer of particles, optionally in a liquid to form a precursor layer for a precursor enhanced internal layer 41. Such a feeder includes conventional heated or unheated double screw mixer/extruders or a feeder such as an IKA MHD mixer available from IKA Works, Inc. of Wilmington, N.C., coupled with a conventional particle metering feeder, like a VibraScrew® particle feeder, and a positive displacement, variable speed drive, pump for the liquid(s). Typical particles are catalysts, fillers, pigments, a metal, sawdust, etc., and typical liquids are polymers, copolymers, or precursors thereof, catalysts, biocides, etc. When particles are not required, or when a layer of viscous liquid is desired, a conventional liquid metering feeder or pump 42 can optionally lay down a layer of liquid 45 onto a previously laid down layer.

Next, a layer of scrap carpet 1 can be laid down continuously from a roll 43 of scrap carpet wound on a rotating mandrel 44 in a known manner. Next, optionally, a layer of shredded carpet 48 can be laid down continuously from a second carpet feeder 36′, an optional second slide 37′ and a second carpet shredder/feeder 38′. Also, optionally, a second layer of particles 41 or particle filled liquid 41,45 can be laid down with a second feeder/mixer 40′ and/or an optional layer of liquid 45 can be laid down continuously with the liquid metering feeder 42′. Next, a second layer of scrap carpet 1 is laid down continuously from the roll 43′ on the mandrel 44′.

At this point, or optionally earlier in the system sequence, a layer 50 can be laid down to form one of the one or more precursor enhanced internal layers 50. For example, a layer of flexible material can be laid down continuously from a roll 46 of flexible material on a rotating mandrel 47. Some examples of such a flexible material includes a fibrous nonwoven mat or woven fabric or scrim made from continuous or staple fibers of glass, polymer, ceramic, metal, carbon, and a natural material and/or any combination thereof. The flexible material could also be scrap carpet backing material, scrap vinyl flooring, and any combination thereof. Optionally, a layer of liquid resin or polymer or other liquid 45 or a liquid suspension or filled polymer or copolymer 41,45 can be laid on top of the layer coming from the roll 46 with an optional liquid feeder 42″ or another liquid/particle feeder like feeder 40 if desired.

Next, one or more optional additional layers of scrap carpet 1 from roll(s) 43″′ on mandrel(s) 44′″ can be laid down followed by optional layers of shredded scrap carpet 48 from feeder 36″′, optional slide 37′″ and shredder 38′″ followed by optional layer or layers of particle filled liquid 41,45 from feeder 40″′ and liquid 45 from liquid feeder 42″. Finally, an optional external layer 19 of material can be laid down, such as from roll 46′ on rotating mandrel 47′ to make the precursor 14. It will be seen that the precursor 14 can contain one or more layers of scrap carpet 1, with one or more optional layer(s) of shredded scrap carpet 48, one or more optional liquid and/or particle layer(s) 41, one or more optional liquid layers 45, and one or more optional precursor enhanced interior layers 50, in any combination, and with one or two optional precursor external layers 19.

The precursor(s) 14 can be processed into hardboard or laminates by separating the precursor 14 into desired lengths with a conventional guillotine cutter or saw (not shown), optionally with heating before or after separation, and pressed as shown in FIG. 7. The precursor 14 can be continuously heated, compacted, cooled and optionally further processed with systems shown in FIGS. 9 and 10.

FIG. 9 shows a continuous heating and consolidating system in which a continuous precursor 14 is processed between a top portion 51 of a lower metal conveyor belt 52 and a lower portion 53 of an upper metal conveyor belt 54. The top portion 51 of the lower metal conveyor belt 52 can optionally carry, move the precursor 14 into an oven 56 to heat the precursor 14 to, or near, the desired consolidation temperature after which the precursor 14 is moved into contact with a lower portion 53 of the upper metal conveyor belt 54 moving at the same speed and direction as moving belt portion 51. Alternatively, this contact of the precursor by both belt portions 51 and 53 can occur before or at the time the precursor 14 enters the oven 56. The top and bottom portions 51 and 53 of the lower metal conveyor belt 52 is supported by spaced apart rollers 55 and later, when pressure is being applied to the heated precursor 14 to consolidate the precursor 14, belt portions 51 and 53 are supported by closely spaced apart rollers 57 and 58 respectively, and/or conventional pressure plates as disclosed in U.S. Pat. No. 4,334,468, the disclosure being incorporated herein by reference. This type of consolidating system is known as a twin or opposed belt forming system and any such system can be used including those available from Sandvik® Process Systems LLC of Totowa, N.J.

The consolidating temperature and magnitude of consolidating pressure and time under pressure applied to the precursor 14 will depend upon the ingredients of the precursor 14 and the type of hardboard and/or laminate being made. After the desired consolidation has been reached, the moving belt portions 51, 53, carry the consolidated precursor 59, usually still under restraining pressure to prevent thickness rebound of the consolidated precursor 59, into a cooling chamber 60 where the consolidated precursor 59, is cooled to a temperature that is at least sufficiently low to prevent undesired thickness rebound. When or after that has been achieved, the moving belt portions 51, 53 transfer the consolidated precursor 59, which can now be either a finished hardboard or laminate product, or an interim product 61 onto a conventional finishing and packaging system (not shown), or onto another transporting system, like a belt conveyor 62 to move the interim product 61 along for further processing and/or finishing.

In the process system shown in FIG. 9, an optional external layer 9 can be applied by laying the layer down from either a roll 64 of the material on a rotating mandrel 65, or alternatively from a stack of sheets or boards (not shown) in a conventional manner. Typical of rolled materials are flexible materials including vinyl decorative film or sheet, water impermeable film or sheet of a polymer, metal, or other material, fibrous woven or nonwoven fabrics, mat or scrim, carpet etc., and typical of sheets or boards include plywood, cementitious backer board, gypsum board, metal, etc. When desirable, an adhesive can be applied to the top of the interim product 61 by a conventional adhesive dispenser 63 to lay down a conventional hot melt, heat setting, or dry setting adhesive to bond the optional external layer 9 to the interim product 61. An optional overhead pressure belt conveyor 66 can be used in a conventional manner to press the optional external layer 9 against the optional adhesive and/or the interim product 61 to bond the optional external layer 9 to the interim product 61 to form a finished laminate product. Closely spaced sets of rollers 68,69 support the working portions of the belts 62,66 respectively. The finished laminate products can then be packaged using conventional equipment.

FIG. 10 shows a shuttle press 71 for making shaped articles according to the invention. An appropriate size of precursor 14, such as disclosed in FIG. 7 above, is cut from any of the precursor types shown in FIGS. 1-6 or other precursors using any known technique including using well known die cutting tool(s). The precursor 14 of desired shape and composition is then fed into the shuttle press 71 and into the peripheral mold 30 by hand or with any known means. The shuttle press 71 has a top platen 72 and a lower bottom platen 74, both, or either, of which can be moved vertically up and down by the rods 24,28. In this embodiment, the top platen 72 is a heated, curved and textured female top die having a textured contact surface 73, e.g. that resembling wood grain. The lower platen 74 is a heated and curved male bottom die 74.

After the precursor 14, cold or preheated, is in place in the shuttle press 71 on the bottom die 74, the dies come together in any manner to contact and deform the precursor and to thermoform, hot press, the precursor 14. After hot pressing to form a curved laminate 76, having a composition as described for FIG. 1 above, the curved laminate 76 can either be cooled in the press sufficiently to maintain its curved shape when ejected, or can be ejected without substantial cooling onto a curved fixture 78 on a takeaway conveyor (not shown) to cool on the fixture 78. The cooled part is then useful in many applications, such as furniture, exterior and interior faux wood columns, etc.

It is also possible to introduce one or more microwave layers between the carpet layers to allow faster preheating of the precursor laminate. Also, one or more electrically conductive layers of metal (particles or sheet) and/or carbon fibers and/or particles could be placed between the carpet layers so electrical resistance heating could be used to provide all or part of the preheating of the precursors. Hardboards or laminates containing one or more electrically conductive layers could be used in electromagnetic wave shielding applications.

Most conventional hot pressing systems capable of the consolidating temperatures and pressures for the scrap carpet and other ingredients disclosed above can be used as the systems disclosed above, or as alternative consolidating systems and methods. Some of these alternative consolidating systems and methods are disclosed in U.S. Pat. Nos. 5,330,595 and 5,460,764, and similar systems and methods. Some examples of consolidating methods and resulting products of the invention are illustrated by the following examples.

### Example 1

One layer or multiple layers of carpet scrap are consolidated at a temperature sufficient for partial melding of the thermoplastic material in the carpet. Due to the partial melting, a certain void content will result as the thermoplastic material is not fully consolidated. The resulting hardboard or laminate is useful as a sound damping material such as an underlayment for laminate flooring.

### Example 2

One or multiple layers of carpet are consolidated under sufficient pressure and heat together with outside layers of fiberglass nonwoven, e.g. a 1.7 lb/100 sq. feet, to achieve a hardboard or laminate of sufficient strength to use the for decking, roofing or similar applications. If better strength and rigidity properties are required, a top layer of woven or a multi-axial continuous multi-fiber strands of glass or high temperature resistant synthetic polymer can be used. The final product also has sufficient strength and mechanical properties to be used as forms for pouring concrete. For this latter application, a smooth top layer is used to allow for easy removing of the boards from the set concrete.

### Example 3

Four layers of carpet, waste or scrap, are consolidated together with one or more layers of glass fiber non-woven mat on the top and bottom, and a durable layer such as a printed film on top of the top layer of non-woven mat are hot consolidated, the temperature and pressure being sufficient to produce a hard laminate. The resultant laminate is useful for building and residential sidings or other decorative building applications.

### Example 4

Partially consolidated waste or scrap layers of carpet are thermoformed into various shapes and used as sound damping material in automotive applications such as door panels, kick panels, package trays, trunk interior panels and other such applications. Heavy fillers, such as barite (barium sulfate), placed between at least two of the layers of carpet enhances the acoustic behavior of the thermoformed parts. The thermoformed parts, having an additional decorative top layer, such as mimicking wood grain, can also be used for flooring, particularly in sporting areas including gymnasiums.

Other embodiments and applications include the following:
Flooring tiles made from one or more carpet layers and having an abrasive layer, skid proof, on the top surface.
Decking tile or strips made from one or more carpet layers with additional reinforcement layers and a decorative top layer.
Laminates made of multiple layers of carpets together with reinforcement layers have sufficient strength to be used in place of plywood and lumber to make temporary shelters for first aid, etc. after catastrophic events.
Thermoformed parts are useful in/for furniture applications such as chairs, tables, furniture for garden and outdoors. Especially when containing honeycomb middle layers to reduce weight. Laminates of the invention containing one or more honeycomb layers can be also used for other construction applications where light weight materials are desirable.
Hardboard and laminates of the invention can be used in applications where WPC (wood plastic compounds) are used today and with superior and/or tailored properties not present in WPC.

Different embodiments employing the concept and teachings of the invention will be apparent and obvious to those of ordinary skill in this art and these embodiments are likewise intended to be within the scope of the claims. The inventor does not intend to abandon any disclosed inventions that are reasonably disclosed but do not appear to be literally claimed below, but rather intends those embodiments to be included in the broad claims either literally or as equivalents to the embodiments that are literally included.

1. A method of making a hardboard or laminate by hot pressing a precursor comprised of one or more layers of scrap carpet at a consolidation temperature above the glass transition temperature of a thermoplastic polymer or copolymer in the scrap carpet to consolidate the precursor into a hardboard or laminate.

2. The method of claim 1 wherein the precursor also contains one or more enhanced interior layers, each enhanced interior layer comprising a material selected from a group consisting of a fibrous material in which the fibers are bound together, woven, or loose, and of any material, pigment and/or filler with or without a binder of any kind, one or more layers of leather, wood or wood product, plastic, ceramic, cementitious material, metal and carbonaceous material and any combination thereof.

3. The method of claim 1 wherein the precursor also contains one or two external layers, each external layer comprising a material selected from a group consisting of a nonwoven material, a decorative paper, a decorative polymer film, a polymer film, a fibrous material in which the fibers are bound together, woven, or loose, and of any material, pigment and/or filler with or without a binder of any kind, one or more layers of leather, wood or wood product, polymer and/or copolymer, ceramic, cementitious material, metal and carbonaceous material and any combination thereof.

4. The method of claim 2 wherein the precursor also contains one or two external layers, each external layer comprising a material selected from a group consisting of a nonwoven material, a decorative paper, a decorative polymer film, a polymer film, a fibrous material in which the fibers are bound together, woven, or loose, and of any material, pigment and/or filler with or without a binder of any kind, one or more layers of leather, wood or wood product, polymer and/or copolymer, ceramic, cementitious material, metal and carbonaceous material and any combination thereof.

5. A hardboard or laminate made by the process of claim 1.

6. A hardboard or laminate made by the process of claim 2.

7. A hardboard or laminate made by the process of claim 3.

8. A hardboard or laminate made by the process of claim 4.

9. The method of claim 1 wherein the consolidation temperature is at least the glass transition temperature of the polymer or copolymer having the highest glass transition temperature in the precursor.

10. The method of claim 2 wherein the consolidation temperature is at least the glass transition temperature of the polymer or copolymer having the highest glass transition temperature in the precursor.

11. The method of claim 3 wherein the consolidation temperature is at least the glass transition temperature of the polymer or copolymer having the highest glass transition temperature in the precursor.

12. The method of claim 4 wherein the consolidation temperature is at least the glass transition temperature of the polymer or copolymer having the highest glass transition temperature in the precursor.

13. A hardboard or laminate made by the process of claim 9.

14. A hardboard or laminate made by the process of claim 10.

15. A hardboard or laminate made by the process of claim 11.

16. A hardboard or laminate made by the process of claim 12.
